(19) United States
(12) Patent Application Publication
(10) Pub. No.: US 2013/0233638 A1
(43) Pub. Date: Sep. 12, 2013

(54) ELECTRIC POWER STEERING APPARATUS FOR VEHICLE

(71) Applicant: MANDO CORPORATION, Pyeongtaek-Si (KR)

(72) Inventor: Jong Hyun LEE, Anyang-si (KR)

(73) Assignee: MANDO CORPORATION, Pyeongtaek-Si (KR)

(21) Appl. No.: 13/791,369

(22) Filed: Mar. 8, 2013

(30) Foreign Application Priority Data
Mar. 12, 2012 (KR) 10-2012-0025090

(51) Int. Cl. B62D 5/04

(52) U.S. Cl. CPC B62D 5/0463; B62D 5/0421
USPC 180/444; 701/42

(57) ABSTRACT

An electric power steering apparatus for a vehicle, includes: a first auxiliary steering unit for assisting with steering power while rotating a steering shaft in a forward or reverse direction with a driving power of a first motor; a second auxiliary steering unit for assisting with steering power while sliding a rack bar in one or an opposite direction with a driving power of a second motor; a torque sensor for detecting a rotary torque of the steering shaft; a speed sensor for detecting a speed of the vehicle; and an electronic control unit for transmitting a target current value control signal to the first motor and the second motor respectively in response to input signals input from the torque sensor and the speed sensor, respectively.

### CROSS-REFERENCE TO RELATED APPLICATION

This application claims priority from and the benefit under 35 U.S.C. §119(a) of Korean Patent Application No. 10-2012-0025090, filed on Mar. 12, 2012, which is hereby incorporated by reference for all purposes as if fully set forth herein.

### BACKGROUND OF THE INVENTION

1. Field of the Invention

The present invention relates to an electric power steering apparatus for a vehicle. More particularly, the present invention relates to an electric power steering apparatus for a vehicle which, by using two auxiliary steering units for assisting steering power when a steering wheel of the driver is manipulated, distributes an auxiliary steering power according to increases in a speed and a weight of the vehicle, reduces a load applied to any one of the auxiliary steering units, reduces operation noise, increases durability, lowers costs and allows for a sufficient auxiliary steering power at the same time by using a low output motor even when being applied to a truck or a bus requiring a relatively high steering power as compared with a car to improve driver convenience and improve the fuel ratio while increasing energy efficiency, and safely maintains a steering operation even if any one of the auxiliary steering units is operating normally while the vehicle is in motion.

2. Description of the Prior Art

In general, a power steering system used in a steering apparatus of a vehicle refers to an apparatus which assists a steering wheel manipulating power of the driver by using a power increasing unit when the driver manipulates the steering wheel of the vehicle so that the direction of the vehicle can be easily changed by a smaller force.

Such power steering systems are largely classified into electric power steering (EPS) systems and hydraulic power steering (HPS) systems.

Among them, the electric power steering systems are steering apparatuses for assisting a manipulating power of a steering wheel with a force of a motor, and are classified into a column type and a rack housing type according to locations of the auxiliary power mechanisms.

FIG. 1 is a diagram of a column type electric power steering apparatus according to the related art.

As illustrated in FIG. 1, the column type electric power steering apparatus includes a power steering mechanism 120 for providing a steering system from steering wheel 101 to two wheels 108 with auxiliary steering power.

One side of the steering shaft 102 is connected to the steering wheel 101 to be rotated together with the steering wheel 101 and an opposite side of the steering shaft 102 is connected to a pinion shaft 104 by means of a pair of universal joints 103.

Further, the pinion shaft 104 is connected to a rack bar 109 through a rack-pinion mechanism 105 and opposite ends of the rack bar 109 are connected to the wheels 108 of the vehicle through a tie rod 106 and a knuckle arm 107. In the rack-pinion mechanism 105, a pinion gear 111 formed in the pinion shaft 104 and a rack gear 112 formed at one side of an outer peripheral surface of the rack bar 109 are engaged with each other so that if the driver manipulates the steering wheel 101, a torque is generated in the steering shaft 102 and the wheels 108 are steered by the torque through the rack-pinion mechanism 105 and the tie rod 106.

The power steering mechanism 120 includes a torque sensor 125 for detecting a torque applied to the steering wheel 101 by the driver and outputting an electrical signal proportional to the detected torque, an electronic control unit (ECU) 123 for generating a control signal based on an electrical signal transmitted from the torque sensor, a motor 130 for generating auxiliary power based on the signal transferred from the electronic control unit 123, and a reducer 140 for transferring the auxiliary power generated by the motor to the steering shaft 102.

FIG. 2 is a schematic diagram of a rack housing type electric power steering apparatus according to the related art.

As illustrated in FIG. 2, the rack housing type electric power steering apparatus includes a power steering mechanism 150 for providing a steering system extending from a steering wheel 101 to two wheels 108 with auxiliary steering power.

In the steering system, one side of a steering wheel 101 is connected to the steering shaft 102 to be rotated together with the steering wheel 101 and an opposite side of the steering wheel 101 is connected to a pinion shaft 104 by means of a pair of universal joints 103.

Further, the pinion shaft 104 is connected to a rack bar 109 through a rack-pinion mechanism 105 and opposite ends of the rack bar 109 are connected to the wheels 108 of the vehicle through a tie rod 106 and a knuckle arm 107. In the rack-pinion mechanism 105, a pinion gear 111 formed in the pinion shaft 104 and a rack gear 112 formed at one side of an outer peripheral surface of the rack bar 109 are engaged with each other so that if the driver manipulates the steering wheel 101, a torque is generated in the steering system 100 and the wheels 108 are steered by the torque through the rack-pinion mechanism 105 and the tie rod 106.

The power steering mechanism 150 includes a torque sensor 121 for detecting a torque applied to the steering wheel 101 by the driver and outputting an electrical signal proportional to the detected torque, an electronic control unit (ECU) 123 for generating a control signal based on an electrical signal transmitted from the torque sensor 121, a motor 151 for generating auxiliary power based on the signal transferred from the electronic control unit 123, and a belt transmission unit 153 for transmitting an auxiliary power generated by the motor 151 by means of a belt to the rack bar 109.

Thus, the electronic power steering apparatus is configured such that a torque generated by rotation of the steering wheel 101 is transmitted to the rack bar 109 via the rack-pinion mechanism 105 and the auxiliary power generated by the motor 151 according to the generated torque is transmitted to the rack bar 109 via a ball screw 155 by the belt type transmission unit 153. Thus, the torque generated in the steering system and the auxiliary power generated by the motor 151 are combined to axially move the rack bar 109.

In the electric power steering apparatus according to the related art, a load applied to one power steering mechanism is increased regardless of speed and weight of the vehicle, causing severe operation noise and deteriorating durability.

Further, a truck or a bus requiring a relatively high steering power as compared with a car should have a high output motor, increasing manufacturing costs, lowering energy efficiency, and decreasing fuel ratio.

Further, if the power steering mechanism is not operating normally while the vehicle is in motion, the vehicle cannot be properly steered, and may cause a fatal accident.

### SUMMARY OF THE INVENTION

Accordingly, the present invention has been made to solve the above-mentioned problems occurring in the prior art, and an object of the present invention is to provide an electric power steering apparatus for a vehicle which, by using two auxiliary steering units for assisting steering power when a steering wheel of the driver is manipulated, distributes an auxiliary steering power according to increases in speed and weight of the vehicle, reduces a load applied to any one of the auxiliary steering units, reduces operation noise, and increases durability

Another objective is to provide an electric power steering apparatus which lowers costs and allows a sufficient auxiliary steering power at the same time by using a low output motor even when being applied to a truck or a bus requiring a relatively high steering power as compared with a car to improve driver convenience and improves fuel ratio while increasing energy efficiency,.

Another objective is to provide an electric power steering apparatus which safely maintains a steering operation even if any one of the auxiliary steering units is not normally operated during a travel of the vehicle.

In order to accomplish this object, there is provided an electric power steering apparatus for a vehicle, including: a first auxiliary steering unit for assisting with steering power while rotating a steering shaft in a forward or reverse direction with a driving power of a first motor; a second auxiliary steering unit for assisting with steering power while sliding a rack bar in one or an opposite direction with a driving power of a second motor; a torque sensor for detecting a rotary torque of the steering shaft; a speed sensor for detecting a speed of the vehicle; and an electronic control unit for transmitting a target current value control signal to the first motor and the second motor respectively in response to input signals input from the torque sensor and the speed sensor, respectively.

As described above, according to the present invention, an electric power steering apparatus for a vehicle distributes an auxiliary steering power according to increases in speed and weight of the vehicle by using two auxiliary steering units for assisting steering power when a steering wheel of the driver is manipulated, reduces a load applied to any one of the auxiliary steering units, reduces operation noise, and increases durability

The electric power steering apparatus lowers costs and allows for a sufficient auxiliary steering power at the same time by using a low output motor even when being applied to a truck or a bus requiring a relatively high steering power as compared with a car to improve driver convenience and improves fuel ratio while increasing energy efficiency,.

The electric power steering apparatus safely maintains a steering operation even if any one of the auxiliary steering units is not normally operated during a travel of the vehicle.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic diagram of a column type electric power steering apparatus according to the related art;

FIG. 2 is a schematic diagram of a rack housing type electric power steering apparatus according to the related art;

FIG. 3 is a schematic diagram illustrating an electric power steering apparatus for a vehicle according to an embodiment of the present invention;

FIG. 4 is a perspective view illustrating the electric power steering apparatus for a vehicle according to the embodiment of the present invention; and

FIGS. 5 and 6 are sectional views illustrating a portion of the electric power steering apparatus for a vehicle according to the embodiment of the present invention.

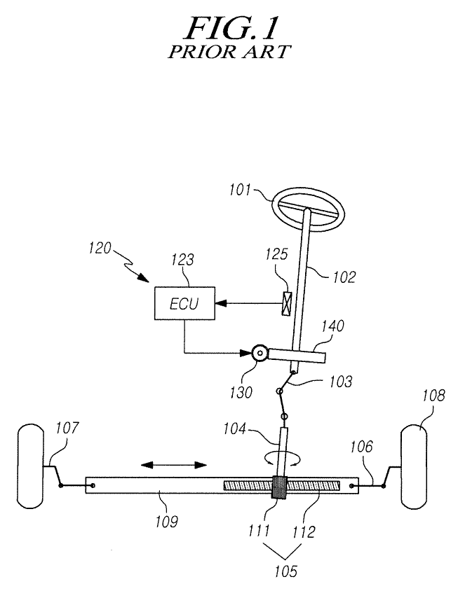

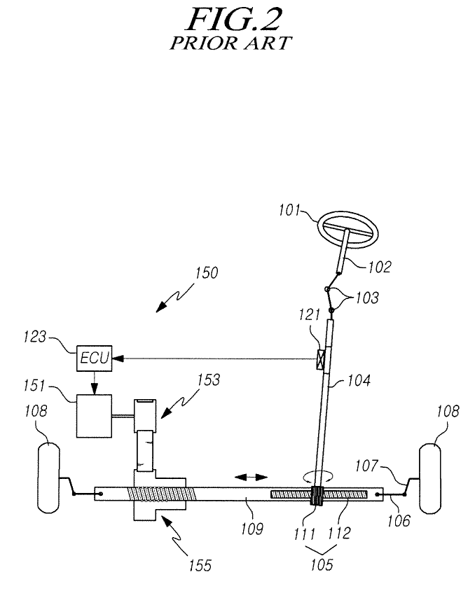

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected”, “coupled” or “joined” to another component, a third component may be “connected”, “coupled”, and “joined” between the first and second components, although the first component may be directly connected, coupled or joined to the second component.

Hereinafter, an electric power steering apparatus for a vehicle according to an embodiment of the present invention will be described in detail with reference to the accompanying drawings.

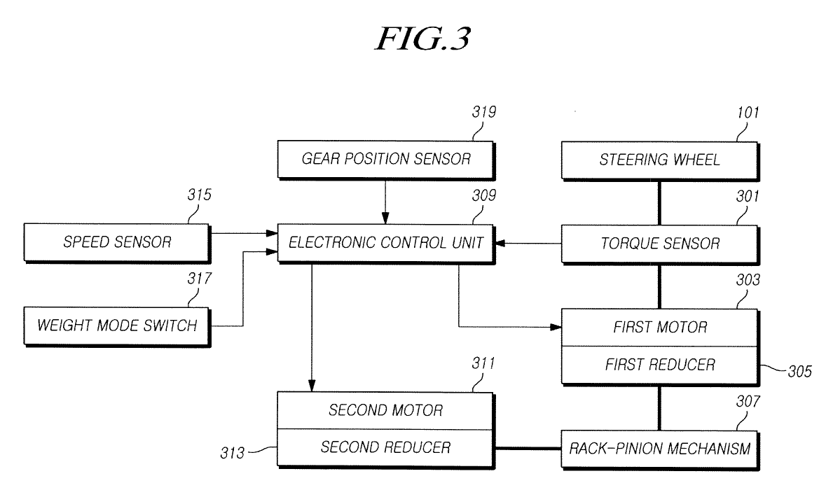

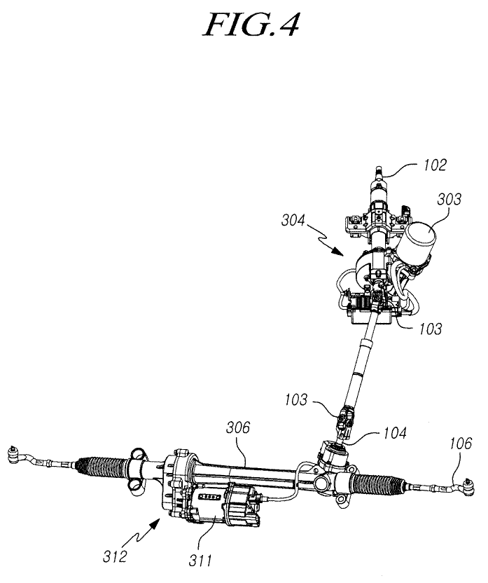

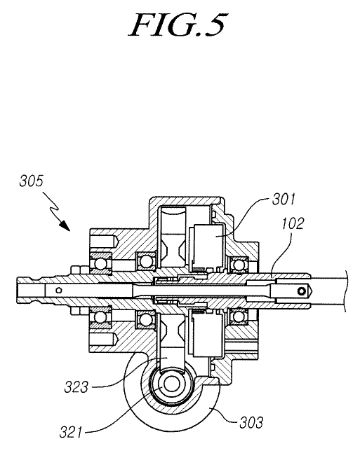

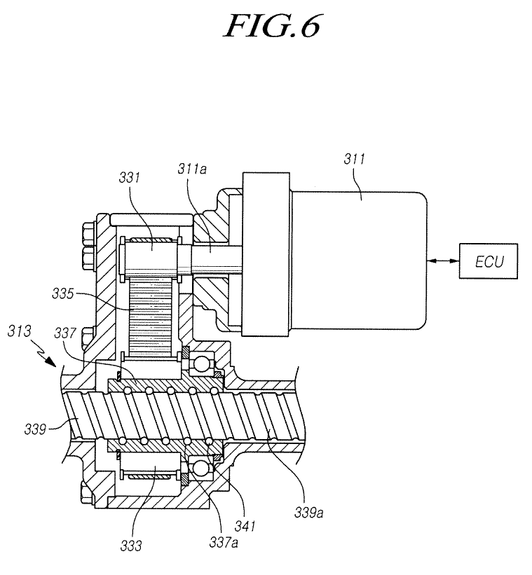

FIG. 3 is a schematic diagram illustrating an electric power steering apparatus for a vehicle according to an embodiment of the present invention. FIG. 4 is a perspective view illustrating the electric power steering apparatus for a vehicle according to the embodiment of the present invention. FIGS. 5 and 6 are sectional views illustrating a portion of the electric power steering apparatus for a vehicle according to the embodiment of the present invention.

As illustrated in the drawings, the electric power steering apparatus for a vehicle according to the embodiment of the present invention includes: a first auxiliary steering unit 304 for assisting with the steering power while rotating a steering shaft 102 in a forward or reverse direction with a driving power of a first motor 303; a second auxiliary steering unit 312 for assisting steering power while sliding a rack bar 339 in one or an opposite direction with a driving power of a second motor 311; a torque sensor 301 for detecting a rotary torque of the steering shaft 102; a speed sensor 315 for detecting a speed of the vehicle; and an electronic control unit 309 for transmitting a target current value control signal to the first motor 303 and the second motor 311, respectively, in response to input signals input from the torque sensor 301 and the speed sensor 315, respectively.

That is, if the torque sensor 301 which detects a rotation direction of a steering shaft 102 rotated in conjunction with the steering wheel 101 when the driver manipulates the steering wheel 101 and a torque value thereof detects whether the driver intends to make a left turn or a right turn, and the torque by which the steering wheel 101 is manipulated, it transmits the data to the electronic control unit 309.

Further, the speed sensor 315 provided in the vehicle detects whether the vehicle is stopped or is moving, and if moving, measures the travel speed and transmits the data to the electronic control unit 309.

The electronic control unit 309 generates a target current value control signal and transmits the target current value control signal to the first auxiliary steering unit 304 and the second auxiliary steering unit 312 to assist with a manipulating power in a direction in which the driver manipulates the steering wheel 101 or an opposite direction in response to the input signals.

The first auxiliary steering unit 304 and the second auxiliary steering unit 312 rotate the steering shaft 102 and slide the rack bar 339, respectively, in a direction the same as or opposite to the rotation direction of the steering wheel 101 of the driver in response to the control signal input from the electronic control unit 309 to assist with a steering power of the driver.

Here, the first auxiliary steering unit 304 includes: a first reducer 305 including a worm wheel 323 connected to the steering shaft 102 to be rotated, and a worm shaft 321 engaged with the worm wheel 323 to rotate the worm wheel 323 connected to the steering shaft 102; and a first motor 303 for driving the worm shaft 321 in a forward or reverse direction in response to a control signal input from the electronic control unit 309.

The second auxiliary steering unit 312 includes: a ball nut 337 coupled to an outer periphery of the rack bar 339 via balls 341 to slide the rack bar 339 in one or an opposite direction while being rotated; a second reducer 313 including a nut pulley 333 coupled to an outer side of the ball nut 337 and to which a belt 335 is coupled, and a motor pulley 331 connected to the nut pulley 333 and the belt 335; and a second motor 311 coupled to the motor pulley 331 to drive the motor pulley 331 in a forward or reverse direction in response to a control signal input from the electronic control unit 309.

The first auxiliary steering unit 304 is an electric auxiliary steering unit using a driving power of the first motor 303, and the first reducer 305 adjusted by rotation of the steering shaft 102 is coupled to the steering shaft 102 so that the steering shaft 102 is rotated by the driving power of the first motor 303.

The first reducer 305 rotates the steering shaft 102 to assist with a steering power of the driver with the driving power of the first motor 303, by working in conjunction with the worm shaft 321 and the worm wheel 323 of the first reducer 305 to perform speed reduction according to gear ratio, and is done largely by the worm wheel 323 and the worm shaft 321. The steering shaft 102 is connected to the center of the worm wheel 323 to be rotated in conjunction with the worm wheel 323 and the worm shaft 321 engaged with the worm wheel 323 is rotated by the driving power of the motor.

Then, the first motor 303 rotates the worm shaft 321 in a forward or reverse direction in response to a control signal input from the electronic control unit 309, that is, a target current value to rotate the worm wheel 323, thereby rotating the steering shaft 102 coupled to a rack-pinion mechanism 307.

The second auxiliary steering unit 312 is an electric auxiliary steering unit using a driving power of the second motor 311, and drives the motor pulley 331 and the nut pulley 333 connected to each other by the belt 335 with a driving power of the second motor 311 to rotate the ball nut 337, thereby sliding the rack bar 339 in one or an opposite direction to assist with a steering power of the driver.

The second auxiliary steering unit 312 performs speed reduction according to a diameter ratio of the motor pulley 331 and the nut pulley 333 constituting the second reducer 313, and if the motor pulley 331 coupled to the motor shaft 311a, it is rotated in a forward or reverse direction of the second motor 311 in response to a control signal input from the electronic control unit 309, the nut pulley 333 is rotated by the belt 335 to rotate the ball nut 337 coupled to the rack bar 339 via the balls 341, thereby sliding the rack bar 339 to one or an opposite side to assist with a manipulating power of the steering wheel 101 of the driver through the rack-pinion mechanism 307.

A screw groove 339a is formed on an outer peripheral surface of the rack bar 339 accommodated in the rack housing 306 and a screw groove 337a corresponding to the screw groove of the rack bar 339 is formed on an inner peripheral surface of the ball nut 337, and a plurality of balls 341 are coupled to the screw grooves 339a and 337a.

Thus, when the ball nut 337 is rotated, the rack bar 339 is slid in one or an opposite direction to operate a tie rod 106, steering the wheels.

Here, the electronic control unit 309 transmits a target current value control signal to the first motor 303 and the second motor 311, respectively in response to an input signal input from the torque sensor 301, and when an input signal value input from the speed sensor 315 is larger than a set vehicle speed, transmission of the target current value control signal to the second motor 311 is stopped.

Thus, when the vehicle travels at a speed higher than a set vehicle speed, an operation of the second auxiliary steering unit 312 is stopped and the vehicle can be steered only with the auxiliary steering power of the first auxiliary steering unit 304, making it possible to minimize power consumption.

Meanwhile, the power steering apparatus of the vehicle may include a weight mode switch 317 for selecting a high weight mode and a low weight mode according to a weight of the vehicle and transmitting the selected mode to the electronic control unit 309.

In this case, the electronic control unit 309 transmits a target current value control signal to the first motor 303 and the second motor 311, respectively, in response to input signals input from the torque sensor 301 and the speed sensor 315. When the input signal input from the weight mode switch 317 corresponds to a high weight mode, a target current value control signal transmitted to the second motor 311 is increased, whereas when the input signal value input from the speed sensor 315 is higher than a set vehicle speed, transmission of a target current value control signal to the second motor 311 is stopped so that when the vehicle travels at a speed higher than a set vehicle speed, the vehicle can be steered only with an auxiliary steering power of the first auxiliary steering unit 304, making it possible to minimize power consumption.

When an input signal input from the weight mode switch 317 corresponds to a low weight mode, the electronic control unit 309 stops transmission of a target current value control signal to the second motor 311 and increases a target current value control signal to the first motor 303. When an input signal value input from the speed sensor 315 is higher than a set vehicle speed, transmission of a target current value control signal to the first motor 303 is decreased and a target current value control signal is stopped transmitting to the second motor 311 so that the vehicle can be steered only with an auxiliary steering power of the first auxiliary steering unit, thereby minimizing power consumption.

That is, operations of the first motor 303 and the second motor 311 are changed according to whether the weight of the vehicle is high or low and the speed of the vehicle is a high speed or a low speed, in which case the vehicle starts in the high weight mode, the first motor 303 and the second motor 311 are simultaneously driven and the driving power of the second motor 311 is increased, and if the increased vehicle speed exceeds a set vehicle speed value, an operation of the second motor 311 is stopped and only the first motor 303 is operated.

On the contrary, in the low weight mode, if the vehicle starts, only a driving power of the first motor 303 is increased, and if the increased speed exceeds the set vehicle speed, a target current value control signal to the first motor 303 is reduced to decrease a driving power of the first motor 303.

Thus, when much freight is loaded on the vehicle or the number of passengers increases, the driver selects a high weight mode through a weight mode switch 317 to obtain more auxiliary steering power, and only the first motor 303 is operated to reduce unnecessary power consumption if the vehicle speed increases.

That is, when less auxiliary steering power is necessary as the vehicle speed is higher than a set value, only the first motor 303 is operated regardless of whether the vehicle is in the high weight mode or the low weight mode, and when a larger amount of auxiliary power steering power is necessary when the vehicle speed is lower than the set value, a high weight mode is selected as described above, the auxiliary power steering powers of both the first motor 303 and the second motor 311 can be used.

Thus, after the electronic control unit 309 determines whether the vehicle makes a left turn or a right turn from the signal of the torque sensor 301 and determines whether the vehicle speed is high or low from the signal of the speed sensor 315, the first and second auxiliary steering units 304 and 312 distribute an amount of auxiliary steering power of the second auxiliary steering unit 312 and transmits a control signal when the vehicle speed is low and an operation of the second auxiliary power steering unit 312 is stopped when the vehicle speed is high.

Further, when the high weight mode is selected even at a low vehicle speed, the auxiliary steering power of the first auxiliary steering unit 304 increases above a normal state, increasing a target current value control signal transmitted to the first motor 303.

That is because since the second auxiliary steering unit 312 coupled to the vehicle is located inside a dash board close to the driver seat, noise audible to the driver is relatively increased as compared with the first auxiliary steering unit 304 located below the engine room, noise transferred to the driver seat can be minimized and auxiliary power steering power can be efficiently used by further increasing an output of the first auxiliary steering unit 304.

Further, a gear position sensor 319 for detecting a position of the transmission gear of the vehicle and transmitting the detected position to the electronic control unit 309 may be further provided.

In this case, when an input signal input from the gear position sensor 319 corresponds to a parking position or a rear gear position, the target current value control signal transmitted to the first motor 303 and the second motor 311 is increased, making it possible to use both the auxiliary steering powers of the first motor 303 and the second motor 311.

Further, when the input signal input from the gear position sensor 319 corresponds to a parking position or a rear gear position and the input signal input from the weight mode switch 317 corresponds to a high weight mode according to selection of the weight mode switch 317, the target current value control signal transmitted to the first motor 303 and the second motor 311 increases.

Further, when the input signal input from the gear position sensor 319 corresponds to a parking position or a rear gear position and the input signal input from the weight mode switch 317 corresponds to a low weight mode, transmission of the target current value control signal to the second motor 311 is stopped and the target current value control signal to the first motor 303 is increased, making it possible to reduce power consumption and efficiently use auxiliary steering power.

Here, the vehicle speed value set to the electronic control unit 309 may vary according to the model of the vehicle, which vehicle speed value ranges from 20 km/h to 40 km/h, and the high weight mode and the low weight mode can be changed and set according to whether the vehicle is a car, a passenger vehicle, or a truck, according to the number of occupants, and according to the weight of loaded freight.

Further, the gear position sensor 319 may be a gear position sensor 319 conventionally used regardless of whether the transmission of the vehicle corresponds to an automatic transmission gear or a manual transmission gear or may be a separate gear position sensor 319 provided in a transmission gear.

Further, a first current sensor for measuring a current value of the first motor 303 and transmitting the current value to the electronic control unit 309 is provided in the first auxiliary steering unit 304, and when a current value input from the first current sensor is different from a target current value transmitted to the first motor 303, the electronic control unit 309 stops transmission of a target current value control signal to the first motor 303 and increases a target current value transmitted to the second motor 311.

Further, a second current sensor for measuring a current value of the second motor 311 and transmitting the current value to the electronic control unit 309 is provided in the second auxiliary steering unit 312. When a current value input from the second current sensor is different from a target current value transmitted to the second motor 311, transmission of a target current value control signal to the second motor 311 is stopped and the target current value transmitted to the first motor 303 is increased.

Thus, if any one of the first auxiliary steering unit 304 and the second auxiliary steering unit 312 are not operating while the vehicle is in motion, auxiliary steering power of one operating normally is increased to continuously assist with a steering power of the driver.

As an example, when an error is generated in the first motor 303 of the first auxiliary steering unit 304, the target current value transmitted to the first motor 303 becomes different from the current value input to the electronic control unit 309. Thus, an operation of the first motor 303 is stopped by stopping transmission of a target current value control signal to the first motor 303 in the electronic control unit 309 and auxiliary steering power can be constantly maintained by increasing the target current value transmitted to the second motor 311.

According to the present invention, an electric power steering apparatus for a vehicle distributes an auxiliary steering power according to increases in speed and weight of the vehicle by using two auxiliary steering units for assisting steering power when a steering wheel of the driver is manipulated, reduces a load applied to any one of the auxiliary steering units, reduces operation noise, and increases durability

The electric power steering apparatus lowers costs and allows for a sufficient auxiliary steering power at the same time by using a low output motor even when being applied to a truck or a bus requiring a relatively high steering power as compared with a car to improve driver convenience and improves fuel ratio while increasing energy efficiency,.

The electric power steering apparatus safely maintains a steering operation even if any one of the auxiliary steering units is not normally operated during a travel of the vehicle.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An electric power steering apparatus for a vehicle, comprising:
a first auxiliary steering unit for assisting with steering power while rotating a steering shaft in a forward or reverse direction with a driving power of a first motor;
a second auxiliary steering unit for assisting with steering power while sliding a rack bar in one or an opposite direction with a driving power of a second motor;
a torque sensor for detecting a rotary torque of the steering shaft;
a speed sensor for detecting a speed of the vehicle; and
an electronic control unit for transmitting a target current value control signal to the first motor and the second motor respectively in response to input signals input from the torque sensor and the speed sensor, respectively. 20

2. The electric power steering apparatus of claim 1, wherein the first auxiliary steering unit comprises:
a first reducer including a worm wheel connected to the steering shaft to be rotated, and a worm shaft engaged with the worm wheel to rotate the worm wheel connected to the steering shaft; and
a first motor for driving the worm shaft in a forward or reverse direction in response to a control signal input from the electronic control unit.

3. The electric power steering apparatus of claim 2, wherein the second auxiliary steering unit comprises:
a ball nut coupled to an outer periphery of the rack bar via balls to slide the rack bar in one or an opposite direction while being rotated;
a second reducer including a nut pulley coupled to an outer side of the ball nut and to which a belt is coupled, and a motor pulley is connected to the nut pulley and the belt; and
a second motor coupled to the motor pulley to drive the motor pulley in a forward or reverse direction in response to a control signal input from the electronic control unit.

4. The electronic power steering apparatus of claim 3, wherein the electronic control unit transmits a target current value control signal to the first motor and the second motor in response to an input signal input from the torque sensor, and stops transmission of the target current control signal to the second motor when an input signal value input from the speed sensor is larger than a set vehicle speed value.

5. The electronic power steering apparatus of claim 3, further comprising a weight mode switch for selecting a high weight mode and a low weight mode according to a weight of the vehicle and transmitting the selected mode to the electronic control unit.

6. The electronic power steering apparatus of claim 5, wherein the electronic control unit increases a target current value control signal transmitted to the second motor when the input signal input from the weight mode switch corresponds to the high weight mode, and stops transmission of a target current value control signal from the second motor when an input signal value input from the speed sensor is larger than a set vehicle speed value.

7. The electric power steering apparatus of claim 5, wherein the electronic control unit stops transmission of a target current value control signal to the second motor and increases a target current value control signal to the first motor when the input signal input from the weight mode switch corresponds to the low weight mode, and decreases a target current value control signal to the first motor when an input signal value input from the speed sensor is larger than a set vehicle speed value.

8. The electric power steering apparatus of claim 3, further comprising a gear position sensor for detecting a position of a transmission gear and transmitting the detected position to the electronic control unit.

9. The electric power steering apparatus of claim 8, wherein when an input signal input from the gear position sensor corresponds to a parking position or a rear gear position, the electronic control unit increases a target current value control signal transmitted to the first motor and the second motor.

10. The electric power steering apparatus of claim 8, further comprising a weight mode switch for selecting a high weight mode and a low weight mode according to a weight of the vehicle and transmitting the selected mode to the electronic control unit.

11. The electric power steering apparatus of claim 10, wherein when the input signal input from the gear position sensor corresponds to a parking position or a rear gear position and the input signal input from the weight mode switch corresponds to a high weight mode, the electronic control unit increases a target current value control signal transmitted to the first motor and the second motor.

12. The electronic power steering apparatus of claim 10, wherein when the input signal input from the gear position sensor corresponds to a parking position or a rear gear position and the input signal input from the weight mode switch corresponds to a low weight mode, the electronic control unit stops transmission of a target current value control signal to the second motor and increases a target current value control signal to the first motor.
